(19) United States
(12) Patent Application Publication
(10) Pub. No.: US 2006/0283678 A1
(43) Pub. Date: Dec. 21, 2006

(54) Dynamic damper

(75) Inventor: Takafumi Murakami, Tochigi-ken (JP)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/452,283

(22) Filed: Jun. 14, 2006

(30) Foreign Application Priority Data
Jun. 15, 2005 (JP) 2005-175417

(51) Int. Cl. F16C 3/00

(52) U.S. Cl. 188/379; 464/180

(57) ABSTRACT

A dynamic damper has a main body, two mass portions projecting from the main body in diametrical directions of a drive shaft, and two connecting portions connecting the main body and the respective mass portions to each other. The connecting portions are narrower than the mass portions. The mass portions accommodate mass members therein, respectively. Each of the mass members comprises a sintered body produced by sintering a powder of a tungsten alloy or tungsten mixed with a metal binder. The tungsten alloy may be W-1.8Ni-1.2Cu, W-3.0Ni-2.0Cu, W-5.0Ni-2.0Fe, or W-3.5Ni-1.5Fe.

### BACKGROUND OF THE INVENTION

1. Field of the Invention

The present invention relates to a dynamic damper for reducing vibrations of a rotating shaft.

2. Description of the Related Art

In recent years, there have been growing needs for dampers for use as a solution to reduce levels of noise, vibration, and harshness (NVH) on automotive bodies. In view of such needs, dynamic dampers have found use on rotating shafts, such as automotive drive shafts, propeller shafts, etc., for reducing unwanted vibrations such as flexural or torsional vibrations caused by unbalanced rotational behavior when the rotating shaft rotates, or vibrations caused by other disturbances.

A dynamic damper, which has a main body and a band, is generally positioned on and fixed to a rotatable shaft such as a drive shaft or the like, with the main body being pressure-fitted over the rotatable shaft and the band tightened around the main body. The main body has a connecting portion projecting diametrically outwardly from an outer circumferential surface thereof, and a mass portion mounted on the connecting portion. The main body, the connecting portion, and the mass portion are integrally formed of a rubber material as a single component. The mass portion includes a mass member made of an iron-based material such as an STKM alloy.

The connecting portion elastically supports the mass portion. When the rotatable shaft rotates and is vibrated, the connecting portion functions as a spring that is extended and compressed in diametrical directions of the rotating shaft, thereby damping and reducing such vibrations.

The dynamic damper thus constructed reduces vibration of the rotating shaft by changing the resonant frequency of the dynamic damper, through an increase or decrease in the mass of the mass member, and by the spring constant of the connecting portion, which can be extended and compressed. However, if the volume of the mass member is increased in order to increase the mass of the mass member for the purpose of changing the resonant frequency, then the mass member needs to have increased dimensions. As a result, the entire dynamic damper itself becomes large in size radially outwardly of the rotating shaft.

A larger-size dynamic damper requires the automobile body to have a wider space to accommodate the dynamic damper therein, posing limitations on latitude when laying out mechanisms and devices on the automobile body. Stated otherwise, the automobile layout is limited, and latitude in designing the automobile is reduced.

Japanese Laid-Open Patent Publication No. 8-277883 discloses a dynamic damper having a plurality of connecting portions with thin films interposed therebetween. When the rotating shaft is vibrated, the thin films are subjected to shearing deformation. The disclosed dynamic damper allows a reduction in dimensions in diametrical directions of the rotating shaft. The rigidity of the thin films can be reduced in order to reduce the spring constant to a negligible level in terms of characteristics of the dynamic damper.

For the purpose of reducing the dimension of the dynamic damper in diametrical directions of the rotating shaft, Japanese Laid-Open Patent Publication No. 9-89047 and Japanese Laid-Open Patent Publication No. 2001-248683 disclose dynamic dampers having a mass member disposed inwardly in diametrical directions of the rotating shaft, in order to bring the connecting members closer to the rotating shaft. However, with the dynamic dampers disclosed in Japanese Laid-Open Patent Publication No. 9-89047 and Japanese Laid-Open Patent Publication No. 2001-248683, the connecting portion causes shearing deformation.

With a structure in which the connecting portions of the dynamic damper cause shearing deformation, although it is possible to reduce the dimension of the dynamic damper in diametrical directions of the rotating shaft, the longitudinal dimension of the dynamic damper increases. Therefore, if the rotating shaft is short, it is difficult to automatically assemble the dynamic damper onto the rotatable shaft. Stated otherwise, ease in assembling the dynamic damper is lowered.

As modern automobiles become more compact and have smaller spaces available therein, the volume of the engine compartment thereof is also reduced. These tendencies have resulted in a demand for smaller-size dynamic dampers. However, most different types of automobiles have different engine compartment sizes, and different dimensions and shapes of mechanisms and devices on the automobiles. Because the latitude in laying out mechanisms and devices on the automobile body is reduced, i.e., because the automobile layout is limited, it is necessary to individually design dynamic damper dimensions and shapes, so as not to interfere with surrounding mechanisms and devices, depending on the automobile type. As a consequence, a large number of different types of dynamic dampers, and a large number of different molds for such different types of dynamic dampers, have to be prepared, and hence large investments for manufacturing facilities are required.

It has been difficult to reduce the size of dynamic dampers to such an extent that they could be installed in different types of automobiles without causing a reduction in the durability of rotating shafts on which the dynamic dampers are mounted.

### SUMMARY OF THE INVENTION

It is a general object of the present invention to provide a dynamic damper, which is effective to prevent a reduction in durability of a rotatable shaft such as a drive shaft or the like on which the dynamic damper is mounted.

A major object of the present invention is to provide a dynamic damper, which can be mounted on any of various types of rotatable shafts for use in many different types of automobiles.

Another object of the present invention is to provide a dynamic damper, which is sufficiently small in size.

According to the present invention, there is provided a dynamic damper for reducing vibrations of a rotating shaft, comprising a main body having a through hole in which the rotating shaft is to be inserted, and a mass portion projecting outwardly from the main body in a diametrical direction of the rotating shaft and accommodating a mass member therein, wherein the mass member comprises a molded body of at least tungsten or a tungsten alloy and a binder. The term “molded body” used therein covers a sintered body.

A mass member made primarily of tungsten or a tungsten alloy has a very high specific gravity. Therefore, if the mass member has the same mass as a conventional mass member made of an iron-based material, then in comparison, the mass member has a very small volume.

Since the mass member has a small size, the dynamic damper itself may be small in size and conserve space. Therefore, the dynamic damper is prevented from interfering with surrounding mechanisms and devices, enabling greater latitude in positioning such mechanisms and devices on an automobile. Stated otherwise, limitations on automobile layout are reduced, and latitude in designing automobiles is increased.

Since latitude in designing automobile layouts is increased, the dimensions and shapes of the dynamic damper do not need to be changed depending on the type of automobile. Accordingly, it is not necessary to design a wide range of different types of dynamic dampers and to prepare a wide range of different molds therefor. As a result, large investments for manufacturing facilities are not required for producing the dynamic damper.

The mass member should preferably have a specific gravity of at least 9. If the specific gravity is smaller than 9, then the mass member tends to become deformed when rubber material is injected around the mass member for forming the dynamic damper.

One preferred example of the binder may be a metal binder. In this case, the mass member may have a relatively large specific gravity, in excess of 14 and up to about 19. Further, if the binder is a metal binder, then the mass member may be made of a sintered metal.

The binder may alternatively be a high-polymer binder, and the mass member may have a relatively small specific gravity, ranging from 9 to about 14. The high-polymer binder makes the mass member relatively pliable, and hence can easily be molded or otherwise machined.

Preferably, the dynamic damper should have a connecting portion for connecting the main body and the mass portion to each other. The connecting portion should preferably be narrower than the mass portion. Since the connecting portion is narrower than the mass portion, the connecting portion is highly flexible. The connecting portion, when constructed in this manner, is susceptible to at least one of tensile and compressive deformation and shearing deformation, preventing the dynamic damper from being large in size along the longitudinal and diametrical directions of the rotatable shaft. The mass portion may thus be reduced in size, so that latitude in designing automobile layouts may be increased.

The dynamic damper may have a plurality of mass portions and a plurality of connecting portions. The mass members may have substantially the same specific gravity and the same weight, or substantially the same specific gravity and different weights (volumes), respectively, or different specific gravities, respectively, and the same weight, or different specific gravities, respectively, and different weights, respectively.

The specific gravity of the mass member can easily be adjusted by changing the type of binder included in the molded body.

When the rotatable shaft rotates, the connecting portions may be subjected to tensile and compressive deformation along diametrical directions of the rotatable shaft, or subjected to shearing deformation along the circumferential direction of the rotatable shaft. Alternatively, the connecting portions may be subjected to both tensile and compressive deformation as well as shearing deformation.

Tensile and compressive deformation refers to the deformation of the connecting portion, as it is extended and compressed along diametrical directions of the rotatable shaft. Shearing deformation refers to the deformation of the connecting portion, as it is pulled along the circumferential direction of the rotatable shaft, which is opposite to the direction in which the rotatable shaft rotates.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a fragmentary cross-sectional view of a drive power transmitting mechanism incorporating a dynamic damper according to an embodiment of the present invention;

FIG. 2 is an enlarged perspective view of the dynamic damper shown in FIG. 1;

FIG. 3 is an enlarged cross-sectional view of the dynamic damper and a nearby region of the drive power transmitting mechanism shown in FIG. 1;

FIG. 4 is an enlarged cross-sectional view of a dynamic damper with a single mass portion;

FIG. 5 is an enlarged cross-sectional view of a dynamic damper with a single mass portion accommodating therein a mass member, which comprises a molded body of STKM alloy;

FIG. 6 is a graph showing latitudes in designing automobile layouts when using the dynamic dampers shown in FIGS. 4 and 5;

FIG. 7 is an enlarged cross-sectional view of a dynamic damper according to another embodiment of the present invention;

FIG. 8 is an enlarged cross-sectional view of a dynamic damper according to still another embodiment of the present invention;

FIG. 9 is a graph showing the relationship between specific gravities and rigidities of mass members;

FIG. 10 is a fragmentary cross-sectional view showing a manner in which a dynamic damper is molded by a mold; and

FIG. 11 is a graph showing the relationship between specific gravities and flexed volumes of mass members.

### DESCRIPTION OF THE PREFERRED EMBODIMENTS

Dynamic dampers according to preferred embodiments of the present invention shall be described in detail below with reference to the accompanying drawings.

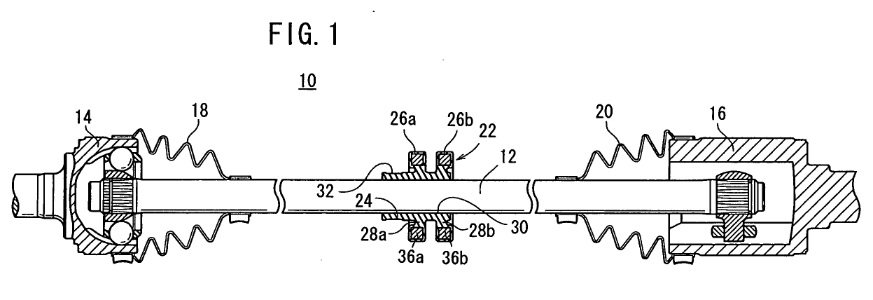

FIG. 1 shows in fragmentary cross section a drive power transmitting mechanism 10, in which a dynamic damper according to an embodiment of the present invention is mounted on a rotatable drive shaft. As shown in FIG. 1, the drive power transmitting mechanism 10 has a drive shaft 12, wherein a Barfield constant-velocity joint 14 and a tripod constant-velocity joint 16 are coupled respectively to opposite ends of the drive shaft 12. Joint boots 18, 20 of synthetic resin are mounted respectively on the Barfield constant-velocity joint 14 and the tripod constant-velocity joint 16. A dynamic damper 22 is mounted substantially centrally on the drive shaft 12 by a fastening band, not shown.

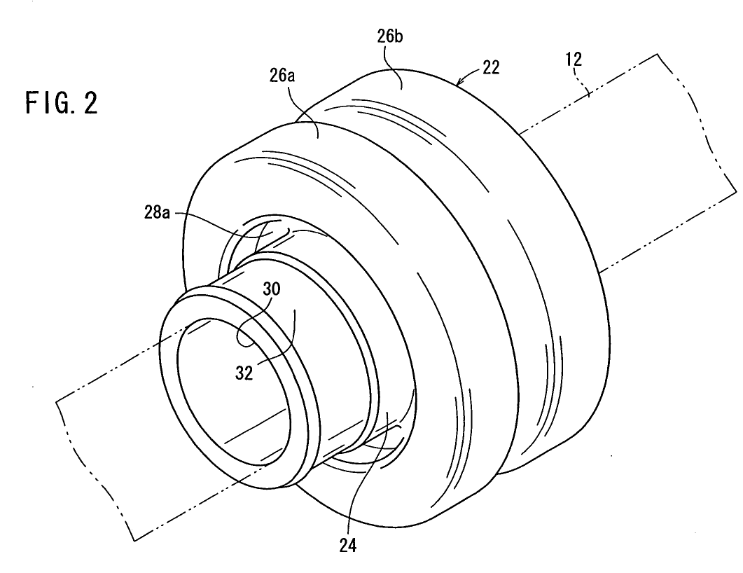

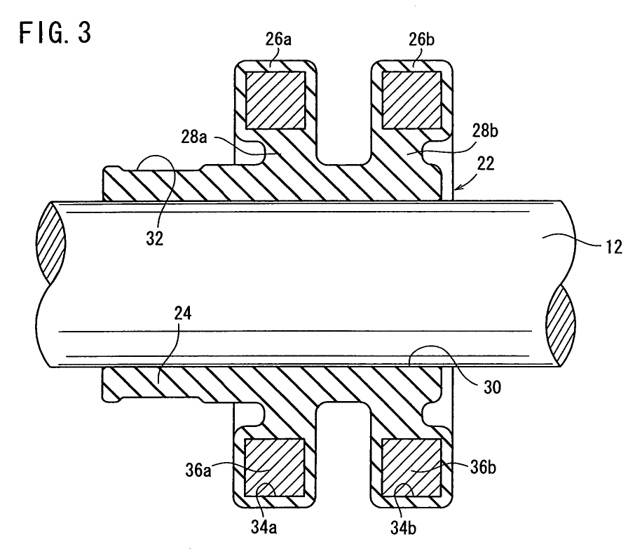

As shown in FIGS. 2 and 3, the dynamic damper 22 comprises a hollow cylindrical main body 24, two mass portions 26a, 26b projecting outwardly from the main body 24 in diametrical directions of the drive shaft 12, and connecting portions 28a, 28b connecting the main body 24 and the respective mass portions 26a, 26b to each other. The main body 24, the mass portions 26a, 26b, and the connecting portions 28a, 28b are integrally molded of a rubber member, thereby forming a single component.

The main body 24 has an axial through hole 30 defined therein, with the drive shaft 12 extending through the through hole 30. The main body 24 has an annular recess 32 defined in an outer surface of a side circumferential wall thereof. A fastening band, not shown, is wound in and around the annular recess 32. When the fastening band is tightened, the dynamic damper 22 is positioned on and fixed to the drive shaft 12 at a given position.

The connecting portions 28a, 28b project outwardly from the main body 24 in diametrical directions of the drive shaft 12. The connecting portions 28a, 28b are narrower than the mass portions 26a, 26b in the axial direction of the dynamic damper 22, and hence are highly flexible. The flexible connecting portions 28a, 28b elastically support the mass portions 26a, 26b, respectively.

The mass portions 26a, 26b are formed annularly along side circumferential walls of the respective connecting portions 28a, 28b. The mass portions 26a, 26b have respective annular spaces 34a, 34b defined therein. Annular mass members 36a, 36b are housed respectively in the annular spaces 34a, 34b. When the drive shaft 12 vibrates, the mass members 36a, 36b are displaced in unison with the respective mass portions 26a, 26b.

Each of the mass members 36a, 36b comprises a sintered body produced by sintering a powder of tungsten alloy mixed with a metal binder. Alternatively, each of the mass members 36a, 36b may comprise a molded body, which is molded from a metal material by a metal injection molding (MIM) or a power injection molding (PIM) process. The mass members 36a, 36b thus constructed have a high specific gravity generally in excess of 14, e.g., a high specific gravity of 17 or higher. Therefore, the mass members 36a, 36b are very heavy.

Preferred examples of the tungsten alloy are W-1.8Ni-1.2Cu having a specific gravity of 18.5, W-3.0Ni-2.0Cu having a specific gravity of 17.8, W-5.0Ni-2.0Fe having a specific gravity of 17.4, and W-3.5Ni-1.5Fe having a specific gravity of 17.6. In the above examples, the numbers given prior to the names of the elements represent weights. %. The specific gravity of the mass members 36a, 36b made of tungsten alloy exceeds twice the specific gravity of mass members made of an iron-based material. Consequently, if the mass members 36a, 36b have the same mass as mass members made of an iron-based material, then the mass members 36a, 36b have a volume that is about one-third to one-half the volume of mass members made of the iron-based material.

Stated otherwise, since the mass members 36a, 36b are made of tungsten alloy, the mass members 36a, 36b are much smaller in size than conventional mass members made of iron-based materials.

The dynamic damper 22 according to the present embodiment is basically constructed as described above. Operations and advantages of the dynamic damper 22 shall be described below.

The drive shaft 12 is inserted through the through hole 30 into the main body 24 of the dynamic damper 22 until the dynamic damper 22 is placed at a desired position on the drive shaft 12. Then, the fastening band is wound and tightened in and around the annular recess 32 of the main body 24. The dynamic damper 22 is now fixed in position on the drive shaft 12.

In the drive power transmitting mechanism 10, which is mounted on an automobile body, the dynamic damper 22 is mounted on the drive shaft 12 in the manner described above. According to the present embodiment, as described above, the mass members 36a, 36b, and hence the mass portions 26a, 26b, have a very small volume. Therefore, the dynamic damper 22 is prevented from interfering with surrounding mechanisms and devices, which thereby can be placed with greater latitude on the automobile. Stated otherwise, a greater selection of automobile layouts is made available.

Inasmuch as the dynamic damper 22 can be installed in any of various different automobile layouts, the dynamic damper 22 can be installed on a wide choice of different automobile types. Stated otherwise, the dimension and shape of the dynamic damper 22 does not need to be changed depending on the type of automobile on which it is to be installed. Accordingly, it is not necessary to design a wide range of different types of dynamic dampers or to prepare a wide range of different molds. As a result, large investments for manufacturing facilities are not required for producing the dynamic damper.

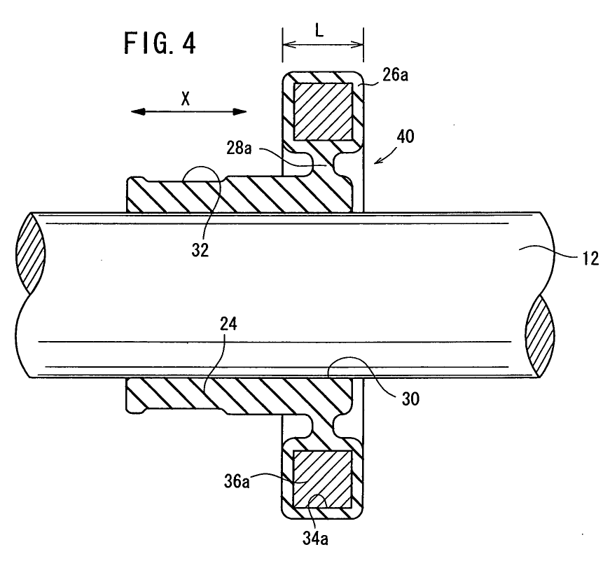

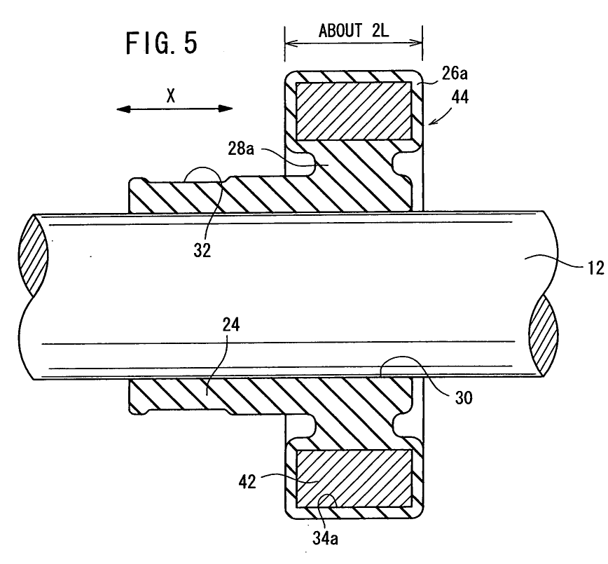

As described above, the mass members 36a, 36b, and hence the mass portions 26a, 26b, have a very small volume. FIG. 4 shows a dynamic damper 40 having a single mass portion 26a accommodating a mass member 36a made of tungsten alloy, and FIG. 5 shows a dynamic damper 44 having a single mass portion 26a accommodating a mass member 42 made of a molded body of STKM alloy. A comparison between FIGS. 4 and 5 indicates that, when the single mass portion 26a is provided, the longitudinal dimension L of the mass member 36a in directions indicated by the arrow X along the drive shaft 12 is about one-half the longitudinal dimension 2L of the mass member 42.

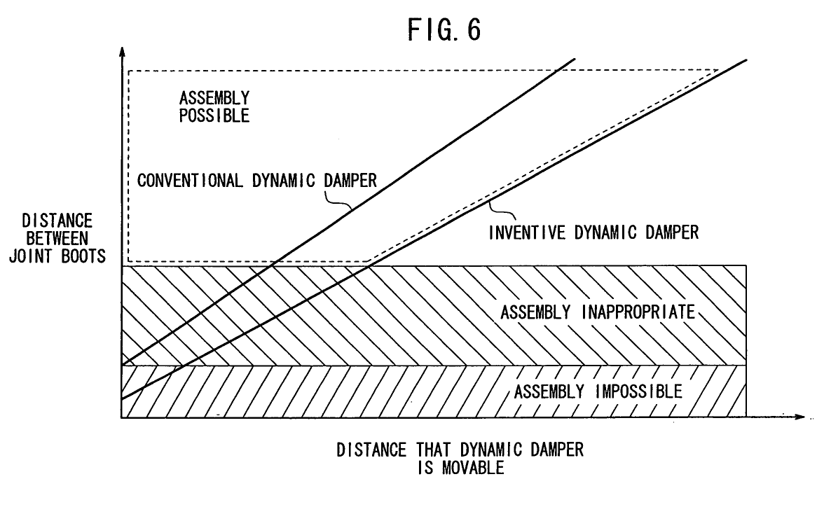

FIG. 6 is a graph showing the relationship between the distance separating the joint boots 18, 20 and the distance that the dynamic damper 22 can be moved. In FIG. 6, the area represented by “ASSEMBLY IMPOSSIBLE” is an area in which the distance between the joint boots 18, 20 is too small to install the dynamic damper 22 therebetween on the drive shaft 12, the area represented by “ASSEMBLY INAPPROPRIATE” is an area wherein the distance between the joint boots 18, 20 is smaller than the minimum dimension required to install the dynamic damper 22 therebetween on the drive shaft 12, and the area represented by “ASSEMBLY POSSIBLE” is an area wherein the distance between the joint boots 18, 20 is sufficient to install the dynamic damper 22 therebetween on the drive shaft 12. Areas on the left side of the straight curves shown in FIG. 6 within the area represented by “ASSEMBLY POSSIBLE” indicate a dimensional relationship, which allows the dynamic damper to actually be installed.

It can be seen from FIG. 6 that by reducing the size of the mass portions 26a, 26b, the distance that the dynamic damper 22 is movable increases, and hence the latitude for designing automobile layouts also increases.

According to the present embodiment, since the mass members 36a, 36b, and hence the mass portions 26a, 26b, are small in size, a plurality of mass portions 26a, 26b may be provided (see FIGS. 2 and 3). The plural mass portions 26a, 26b are effective to efficiently absorb vibratory energy generated by the drive shaft 12, and hence appropriately reduce vibration of the drive shaft 12.

When the drive shaft 12 is vibrated for some reason, the mass portions 26a, 26b accommodating the mass members 36a, 36b, respectively, are subjected to tensile and compressive deformation and/or shearing deformation through the connecting portions 28a, 28b.

Specifically, when the drive shaft 12 is undesirably vibrated, vibrations are propagated from the main body 24 through the connecting portions 28a, 28b to the mass portions 26a, 26b. At this time, the mass portions 26a, 26b which accommodate the respective mass members 36a, 36b, and which have resonant frequencies matching the frequency of the undesirable vibrations of the automobile, are extended and compressed, i.e., are subjected to tensile and compressive deformation, based on the connecting portions 28a, 28b in diametrical directions of the drive shaft 12.

Alternatively, the connecting portions 28a, 28b may be deformed in a circumferential direction of the drive shaft 12, which is opposite to the direction in which the drive shaft 12 rotates, i.e., the connecting portions 28a, 28b may be subjected to shearing deformation. Of course, the connecting portions 28a, 28b may be subjected to both tensile and compressive deformation together with shearing deformation.

When the connecting portions 28a, 28b are subjected to tensile and compressive deformation and/or shearing deformation, the mass portions 26a, 26b (the mass members 36a, 36b) resonate. At this time, inasmuch as the mass portions 26a, 26b are substantially identical in shape to each other, they have substantially the same resonant frequency. The connecting portions 28a, 28b absorb vibratory energy generated by the drive shaft 12 and appropriately reduce vibrations of the drive shaft 12.

Specifically, vibrations of the drive shaft 12 are reduced as a result of resonance of the mass portions 26a, 26b (the mass members 36a, 36b), which are elastically supported by the flexible connecting portions 28a, 28b.

Because the connecting portions 28a, 28b are narrower than the mass portions 26a, 26b, the connecting portions 28a, 28b are highly flexible with respect to the mass portions 26a, 26b. The flexible connecting portions 28a, 28b are susceptible to tensile and compressive deformation and/or shearing deformation, making it possible to reliably reduce vibrations of the drive shaft 12.

According to the present embodiment, as described above, the connecting portions 28a, 28b of the dynamic damper 22 are subjected to at least one of tensile and compressive deformation and shearing deformation. If the connecting portions 28a, 28b are subjected only to shearing deformation, then the dimension of the dynamic damper along longitudinal directions of the drive shaft 12 increases, and if the connection portions 28a, 28b are subjected to only tensile and compressive deformation, then the dimension of the dynamic damper along diametrical directions of the drive shaft 12 increases. However, the dynamic damper 22 according to the present embodiment may have reduced dimensions along both longitudinal and diametrical directions of the drive shaft 12. Therefore, ease in assembling the dynamic damper 22 on the drive shaft 12 also is increased.

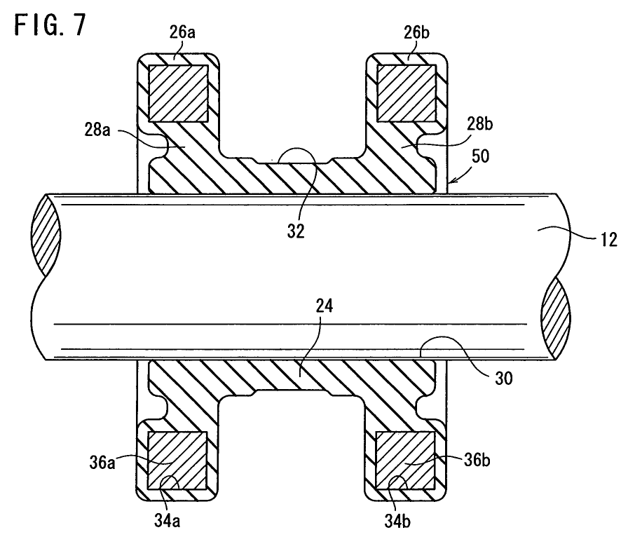

In the above embodiments, the two mass portions 26a, 26b are disposed closely to each other (see FIGS. 2 and 3). However, as shown in FIG. 7, the dynamic damper 50 may have mass portions 26a, 26b positioned respectively on opposite ends of the main body 24. The dynamic damper may have a single mass portion, as shown in FIG. 4, or three or more mass portions.

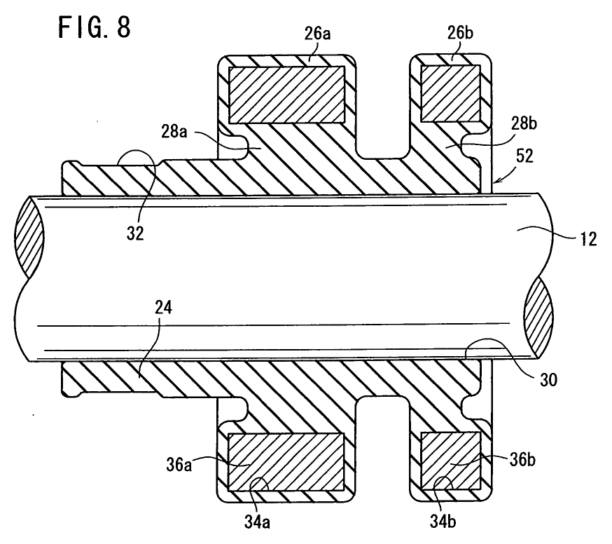

In the present embodiment, the mass portions 26a, 26b, the mass members 36a, 36b, and the connecting portions 28a, 28b are substantially identical in shape, and the connecting portions 28a, 28b provide substantially the same resonant frequency. However, as shown in FIG. 8, the dynamic damper 52 may have mass portions 26a, 26b, mass members 36a, 36b, and connecting portions 28a, 28b which are different in shape, and further, the connecting portions 28a, 28b may have different spring constants, respectively, for increasing the range by which the resonant frequency can be set.

According to still another dynamic damper, the main body 24 and the mass portions 26a, 26b may be joined to each other, thus dispensing with the connecting portions 28a, 28b. Alternatively, the connecting portions 28a, 28b may be included within the mass portions 26a, 26b.

The mass members 36a, 36b may have different specific gravities while being identical in dimension. The specific gravities may be adjusted by changing the types and amounts of a high-polymer binder and a metal binder.

The tungsten powder alloy may be replaced with tungsten powder, and the mass members may be molded from tungsten powder by any of a sintering process, an MIM process, or a PIM process.

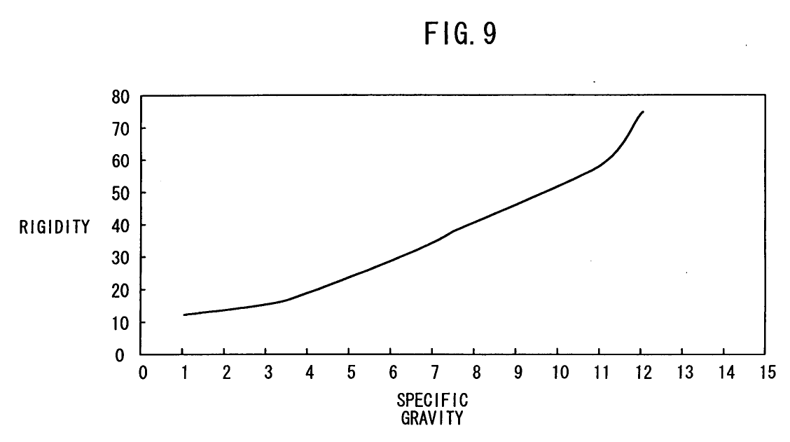

The metal binder may be replaced with a high-polymer binder. If a resin binder is used as such a high-polymer binder, then mass members having a specific gravity ranging from 7 to 16 are produced. If a rubber binder is used as such a high-polymer binder, then mass members having a specific gravity of about 13 are produced. FIG. 9 shows the relationship between specific gravities and the rigidity of the mass members 36a, the specific gravities being obtained by different ratios of a high-polymer binder and a tungsten powder alloy. A study of FIG. 9 indicates that as the specific gravity is higher, rigidity also becomes higher.

If a high-polymer binder is used, then the mass member should preferably have a specific gravity in a range from 9 to 14. This specific gravity range is selected for the following reasons:

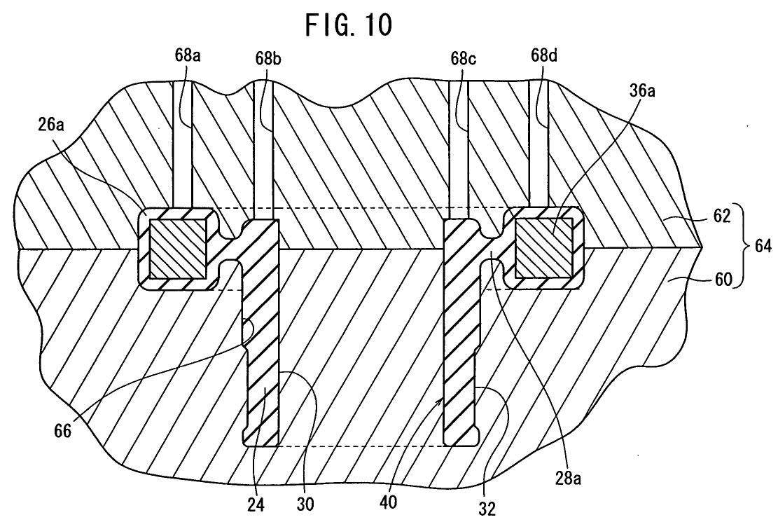

For producing the dynamic damper 40 shown in FIG. 4, the mass member 36a is placed in a cavity 66 (see FIG. 10) inside of a mold 64, which comprises a lower mold member 60 and an upper mold member 62, and a rubber material is injected into the cavity 66 through supply passages 68a, 68b, 68c, 68d defined in the upper mold member 62. At this time, the mass member 36a is pressed by the rubber material flowing into the cavity 66. Stated otherwise, a pressing force acts on the mass member 36a.

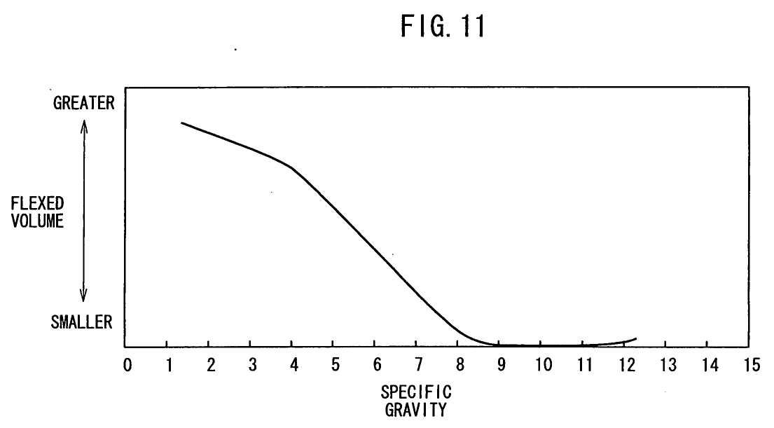

In FIG. 11, the flexed volume of the mass member 36a, which is pressed under the pressing force, is shown in relation to the specific gravity thereof. It can be understood from FIG. 11 that the mass member 36a is not flexed if the specific gravity is 9 or greater.

If the specific gravity exceeds 14, then the relative amount of the high-polymer binder is reduced. Therefore, the tungsten powder alloy or the tungsten powder may not be bound together sufficiently, potentially resulting in a reduction in the mechanical strength of the mass member 36a.

Preferred examples of the resin binder are nylon resin and polystyrene-based thermoplastic elastomer resin. The mass member 36a may be fabricated according to an injection molding process or a pressing process.

Although certain preferred embodiments of the present invention have been shown and described in detail, it should be understood that various changes and modifications may be made without departing from the scope of the invention as set forth in the appended claims.

What is claimed is:

1. A dynamic damper for reducing vibrations of a rotating shaft, comprising:
a main body having a through hole for the rotating shaft to be inserted therethrough; and
a mass portion projecting outwardly from said main body in a diametrical direction of the rotating shaft and accommodating a mass member therein,
wherein said mass member comprises a molded body of at least tungsten or a tungsten alloy and a binder.

2. A dynamic damper according to claim 1, wherein said mass member has a specific gravity of at least 9.

3. A dynamic damper according to claim 2, wherein said binder comprises a metal binder, and said mass member has a specific gravity in excess of 14.

4. A dynamic damper according to claim 2, wherein said binder comprises a high-polymer binder, and said mass member has a specific gravity of at most 14.

5. A dynamic damper according to claim 1, further comprising:
a connecting portion connecting said main body and said mass portion to each other.

6. A dynamic damper according to claim 5, wherein said connecting portion is narrower than said mass portion.

7. A dynamic damper according to claim 1, comprising a plurality of said mass portions.

8. A dynamic damper according to claim 7, comprising a plurality of said connecting portions, said connecting portions connecting said main body and said mass portions, respectively, to each other.

9. A dynamic damper according to claim 7, wherein said mass portions accommodate respective mass members therein, said mass members having substantially the same specific gravity and the same weight.

10. A dynamic damper according to claim 7, wherein said mass portions accommodate respective mass members therein, said mass members having substantially the same specific gravity and different weights, respectively.

11. A dynamic damper according to claim 7, wherein said mass portions accommodate respective mass members therein, said mass members having different specific gravities, respectively, and the same weight.

12. A dynamic damper according to claim 7, wherein said mass portions accommodate respective mass members therein, said mass members having different specific gravities, respectively, and different weights, respectively.

13. A dynamic damper according to claim 7, comprising two mass portions, one of said mass portions being mounted on an end of said main body and the other mass portion being mounted on said main body near said one of the mass portions mounted on the end of said main body.

14. A dynamic damper according to claim 7, comprising two mass portions, one of said mass portions being mounted on an end of said main body and the other mass portion being mounted on another end of said main body.
